(19) United States
(12) Patent Application Publication
(10) Pub. No.: US 2008/0170099 A1
(43) Pub. Date: Jul. 17, 2008

(54) INKJET IMAGE FORMING APPARATUS

(75) Inventors: Jung-dae Heo, Suwon-si (KR); Jin-ho Park, Giheung-gu (KR); Dong-woo Ha, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/843,868

(22) Filed: Aug. 23, 2007

(30) Foreign Application Priority Data
Jan. 12, 2007 (KR) 2007-0003925

(51) Int. Cl. B41J 29/38; B41J 2/175; B41J 2/165

(52) U.S. Cl. 347/32

(57) ABSTRACT

An inkjet image forming apparatus capable of circulating ink provided from an ink cartridge includes at least one pump disposed at an ink cartridge that is detachably disposed to a main body frame, at least one pump driving unit to drive the at least one pump, and a driving motor to drive the at least one pump driving unit if rotating in a first direction. The driving motor drives another part of the image forming apparatus if rotating in a second direction.

### CROSS-REFERENCE TO RELATED APPLICATIONS

This application claims the benefit under 35 U.S.C. § 119(a) from Korean Patent Application No. 2007-0003925 filed Jan. 12, 2007 in the Korean Intellectual Property Office, the disclosure of which is incorporated herein by reference in its entirety.

### BACKGROUND OF THE GENERAL INVENTIVE CONCEPT

1. Field of the General Inventive Concept

The present general inventive concept relates to an inkjet image forming apparatus. More particularly, the present general inventive concept relates to an inkjet image forming apparatus having at least one pump to circulate ink of an ink cartridge.

2. Description of the Related Art

Generally, an inkjet image forming apparatus such as an inkjet printer is an apparatus that forms extremely small droplets of ink, and then fires droplets of ink onto a printing medium such as a sheet of paper, a textile fabrics, etc. to create predetermined images.

A conventional inkjet image forming apparatus includes an ink cartridge that reciprocates linearly in a direction transverse to a printing medium transferring direction and forms images on the printing medium. Typically, this reciprocation direction is in a width direction of the printing medium. Thus, the term “width” as used in this disclosure is independent of the size of the printing medium. The term “width” as used in this disclosure, when referring to the printing medium, indicates the direction transverse to the printing medium transferring direction even in the case where the printing medium has such a size that its length in the transferring direction is less than its length transverse to the transferring direction. However, the conventional inkjet image forming apparatus that reciprocates the ink cartridge to form images has a problem that a printing speed is slow.

To solve the above-described problem, there recently has been proposed an inkjet image forming apparatus that uses an ink cartridge having a plurality of print heads arranged along the whole width of the printing medium. The inkjet image forming apparatus can print at a high speed because printing does not require the ink cartridge to reciprocate.

The ink cartridge capable of forming images without the reciprocation includes a plurality of ink tanks to store ink for printing, a plurality of print heads that are arranged to correspond to the width of a printing medium in a width direction thereof, and an ink channel unit to carry ink from the plurality of ink tanks to the plurality of print heads.

The plurality of ink tanks may be detachably mounted to a frame of the ink cartridge and store various different color inks, for example, yellow ink, magenta ink, cyan ink, and black ink, respectively.

The ink channel unit is connected to each of the plurality of ink tanks and supplies ink from the ink tanks to each of the plurality of print heads.

The plurality of print heads are arranged and attached in a predetermined pattern to a front side of the ink channel unit. Each of the plurality of print heads has a plurality of nozzles to fire ink. Ink supplied from the ink channel unit is fired onto a printing medium via the nozzles, thereby forming an image on the printing medium.

However, the conventional inkjet image forming apparatus has some delay after turning on until ink is supplied from the ink tank to the print heads to be ready to print. Also, when the ink tank is replaced or when the ink cartridge is detached from and mounted to a main body of the inkjet image forming apparatus, bubbles forming in an ink circulation system may prevent ink from being supplied to the print head.

Also, when bubbles occur in ink due to the heat of the print head during printing, the ink cannot be supplied smoothly to the print head. If ink is not supplied smoothly to the print head, poor quality images are obtained.

### SUMMARY OF THE GENERAL INVENTIVE CONCEPT

The present general inventive concept provides an inkjet image forming apparatus having a pump to circulate ink between an ink tank and a print head.

Additional aspects and utilities of the present general inventive concept will be set forth in part in the description which follows and, in part, will be obvious from the description, or may be learned by practice of the general inventive concept.

The foregoing and/or other aspects, features and/or utilities of the present general inventive concept may be achieved by providing an inkjet image forming apparatus, which includes at least one pump. The at least one pump may be disposed at an ink cartridge that is detachably disposed at a main body frame. Further, at least one pump driving unit may be provided to drive the at least one pump. A driving motor may drive the at least one pump driving unit when rotating in a first direction and the driving motor to drive another part of an image forming apparatus when rotating in a second direction. A controller may be used to control the driving motor.

Examples of the driving motor include a dead nozzle compensation motor, a pickup motor, a feed motor, and a discharging motor.

The at least one pump driving unit may include a pumping lever rotatably disposed at the ink cartridge and having an upper portion thereof connected with an operating rod of the at least one pump; a pumping cam disposed near a lower portion of the pumping lever and formed to move the operating rod when the pumping cam contacts the lower portion of the pumping lever; and a driving unit to receive power from the driving motor, and then to rotate the pumping cam.

The driving unit may include a cam shaft rotatably disposed at the main body frame and a pump gear disposed at an end of the cam shaft to receive power from the driving motor.

The driving unit may include a one-way clutch disposed between the pump gear and the cam shaft.

Also, the inkjet image forming apparatus may include a returning member disposed at the operating rod to return the operating rod to its original position.

The controller may cause the driving motor to rotate in the first direction when the image forming apparatus is turned on, when the ink cartridge is separated from and then again disposed at the main body frame, and/or when an ink tank of the ink cartridge is replaced.

Also, if the amount of fired ink reaches a reference value during a printing operation, the controller may cause the driving motor to rotate in the first direction.

According to another aspect of the present general inventive concept, an inkjet image forming apparatus may include a plurality of pumps disposed at an ink cartridge that is detachably disposed at a main body frame; a pump driving unit to drive the plurality of pumps; a dead nozzle compensation motor to drive the pump driving unit if rotating in a first direction and the driving motor to drive a compensation roller if rotating in a second direction; and a controller to control the dead nozzle compensation motor.

The plurality of pumps may be disposed in pairs at the ink cartridge.

The plurality of pumps may include two pair of pumps disposed at opposite edges of the ink cartridge. The pump driving unit may include first and second pumping levers rotatably disposed at the ink cartridge and having an upper portion thereof to press at the same time two operating rods of the pair of pumps; first and second pumping cams disposed near a lower portion of each of the first and second pumping levers and formed for the first and second pumping levers to press the operating rods of the two pairs of pumps when the first and second pumping cams contact the lower portion of each of the first and second pumping levers; and a driving unit to receive power from the dead nozzle compensation motor, and then to rotate the first and second pumping cams.

The pump driving unit may include a connection member disposed at the upper portion of each of the first and second pumping levers and connected with the operating rods of the pair of pumps.

The inkjet image forming apparatus may include a returning member disposed at the operating rod of each of the plurality of pumps to return the operating rod to its original position.

The driving unit may include a cam shaft rotatably disposed at the main body frame; and a pump gear disposed at an end of the cam shaft to receive power from the dead nozzle compensation motor.

The controller may cause the dead nozzle compensation motor to rotate in the first direction when the inkjet image forming apparatus is turned on, when the ink cartridge is separated from and then again disposed at the main body frame, and/or when an ink tank of the ink cartridge is replaced.

Also, if the amount of fired ink reaches a reference value during a printing operation, the controller may cause the dead nozzle compensation motor to rotate in the first direction.

The foregoing and/or other aspects, features and/or utilities of the present general inventive concept may also be achieved by providing an image forming apparatus including a main body frame, an ink cartridge removably attached to the frame, the ink cartridge including at least one ink tank, a plurality of print heads arranged in a direction transverse to a travel direction of a printing medium to eject ink onto the printing medium, and at least one pump in fluid communication with the ink tank, and a motor fixed to said main body frame having a drive shaft in mechanical communication with said at least one pump to transmit a mechanical force to operate said at least one pump.

The motor may be shared to drive other mechanical elements of the printer during a period of time that the pump is not operating.

The inkjet printer may include a clutch connected to the motor to transmit the mechanical force to operate said at least one pump only when the drive shaft of the motor rotates in a first direction.

The inkjet printer may include a controller to operate the at least one pump in as part of an initialization routine after the inkjet printer is turned on.

The inkjet printer may further include a controller to operate the at least one pump to be turned on in response to attaching said ink cartridge to said main body frame.

The foregoing and/or other aspects, features and/or utilities of the present general inventive concept may be achieved by providing an ink cartridge usable with an inkjet printer, which includes a cartridge frame, at least one ink tank disposed within the cartridge frame, at least one pump disposed within the cartridge frame in fluid communication with the ink tank and including at least one operating rod for operating a corresponding at least one pump, at least one lever rotatably connected to said cartridge frame by a hinge, the at least one lever operable to exert a force on a corresponding at least one operating rod when a portion of said lever receives a mechanical force exterior from said cartridge frame, and a plurality of print heads exposed through holes in said cartridge frame and arranged in a direction transverse to a travel direction of a printing medium to eject ink onto the printing medium.

The at least one lever may be mounted to an interior portion of the cartridge frame and includes a terminal portion extending through a corresponding at least one hole in the cartridge frame to receive the mechanical force exterior from said cartridge frame.

The ink cartridge may include a channel member providing a fluid communication channel between said at least one ink tank and said print heads, wherein operating of said at least one pump circulates ink within said channel member to remove bubbles.

The foregoing and/or other aspects, features and/or utilities of the present general inventive concept may also be achieved by providing an ink cartridge usable with an image forming apparatus which includes a body frame, at least one ink tank mounted in the body frame to supply ink, a plurality of print heads mounted in the body frame and arranged in a direction traverse to a travel direction of a printing medium to eject the supplied ink onto the printing medium, and at least one pump mounted in the body frame in fluid communication with the ink tank and at least one corresponding one of the plurality of print heads.

Other objects, advantages and salient features of the general inventive concept will become apparent from the following detailed description, which, taken in conjunction with the annexed drawings, discloses preferred embodiments of the general inventive concept.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating an inkjet image forming apparatus according to an embodiment;

FIG. 2 is a perspective view illustrating a pump and a pump driving unit used in the inkjet image forming apparatus of FIG. 1;

FIG. 3 is a perspective view illustrating an ink cartridge used in the inkjet image forming apparatus of FIG. 1;

FIG. 4 is a bottom perspective view illustrating the ink cartridge of FIG. 3;

FIG. 5 is a side view illustrating the pump driving unit of FIG. 2 before operating the pump; and

FIG. 6 is a side view illustrating the pump driving unit of FIG. 2 when operating the pump.

Throughout the drawings, like reference numerals will be understood to refer to like parts, components and structures.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The following description, including description of a detailed construction and elements thereof, are provided as detailed examples to assist in a comprehensive understanding. Thus, it is apparent that the present general inventive concept may be carried out without requiring the particular details of the examples and may be carried out by a myriad of other implementations. Also, well-known functions or constructions may be omitted to provide a clear and concise description of exemplary embodiments of the present general inventive concept.

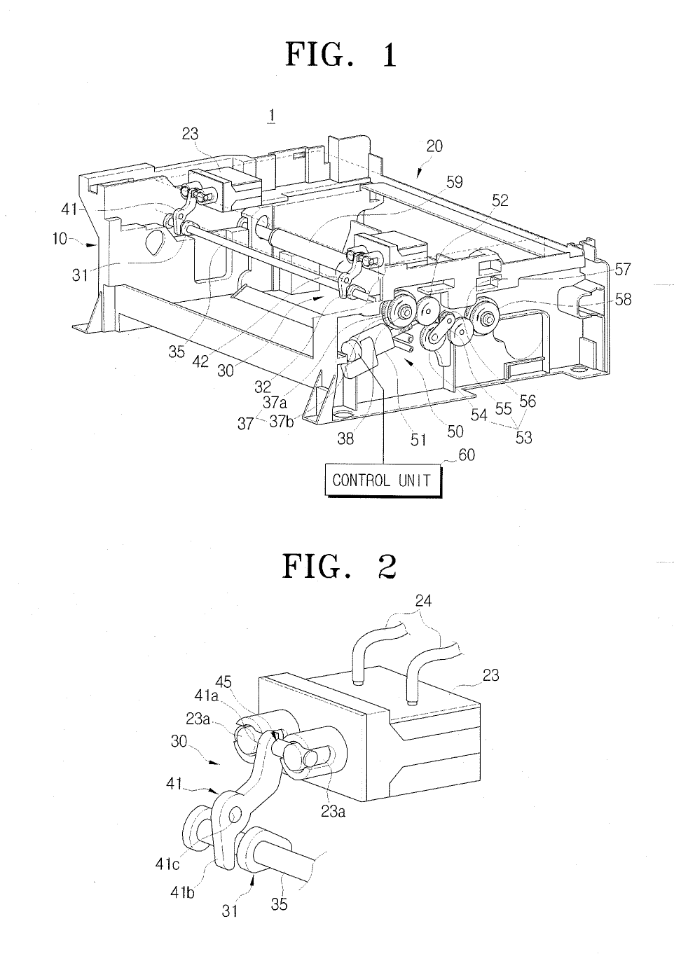

FIG. 1 is a perspective view illustrating an inkjet image forming apparatus 1 according to one exemplary embodiment. However, in FIG. 1, to clearly illustrate a pump and a pump driving unit the following elements generally may be found in a conventional image forming apparatus are not illustrated: a printing medium pickup unit, a printing medium transferring unit, a printing medium discharging unit. Also, excepting the pump, an ink cartridge is illustrated by a dotted line to show a contour thereof.

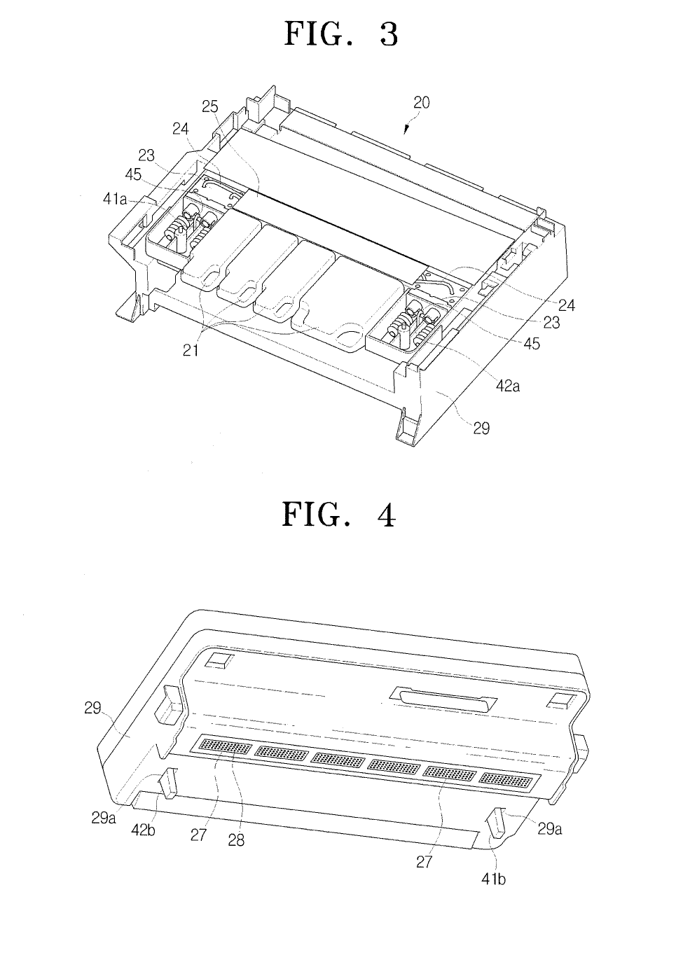

Referring to FIGS. 1 and 3, the inkjet image forming apparatus 1 according to an exemplary embodiment includes a main body frame 10, an ink cartridge 20, a pump driving unit 30, a dead nozzle compensation unit 50, and a control unit 60, here a controller.

The main body frame 10 supports the ink cartridge 20, a printing medium pickup unit (not illustrated) to pick up printing media one by one and a printing medium transferring unit (not illustrated) to transfer a picked up printing medium under the ink cartridge 20. Therefore, at the main body frame 10, a pickup motor (not illustrated) may be disposed to drive a pickup roller (not illustrated) of the printing medium pickup unit and a feed motor (not illustrated) may be disposed to drive a feed roller (not illustrated) of the printing medium transferring unit. Also, the main body frame 10 supports a printing medium discharging unit (not illustrated) to discharge a printing medium on which images were formed by the ink cartridge 20 outside the inkjet image forming apparatus 1. Therefore, a discharge motor (not illustrated) may also be disposed at the main body frame 10 to drive a discharge roller (not illustrated) of the printing medium discharging unit.

As another example, an inkjet image forming apparatus may be configured so that a main motor and a power transmitting unit drive all of the pickup roller, the feed roller and the discharge roller. At this time, the main motor and the power transmitting unit are disposed at the main body frame 10.

The ink cartridge 20 is disposed at an upper portion of the main body frame 10 to fire ink onto and form a predetermined image on a printing medium transferred by the printing medium transferring unit. Referring to FIGS. 3 and 4, the ink cartridge 20 in this example includes a plurality of ink tanks 21, a plurality of pumps 23, an ink channel unit 25, a plurality of print heads 27, and a cartridge frame 29.

The plurality of ink tanks 21 holds ink for printing and is detachably disposed at the cartridge frame 29. The ink cartridge 20 according to this embodiment has four ink tanks 21 to form color images. Four ink tanks 21 hold yellow ink, magenta ink, cyan ink, and black ink, respectively.

Each of the plurality of pumps 23 supplies the ink channel unit 25 with ink of a corresponding ink tank 21 and forces the return of ink in the ink channel unit 25 to the ink tank 21, thereby circulating ink. When the pump 23 circulates ink, bubbles which may have occurred in an ink circulation system are removed. In this example, there is one pump 23 connected to each ink tank 21. Thus, the ink cartridge 20 according to this embodiment is provided with four pumps 23 corresponding to the four ink tanks 21. Here, the ink circulates between the ink channel unit 25 and the corresponding ink tanks 21 by the corresponding ink pumps 23. Since the print heads 27 are fluidly connected to the ink channel unit 25, the ink of the ink channel unit 25 may be supplied to the print heads 27 by the force of gravity, and the circulation of the ink of the ink channel unit 25 may include an indirect circulation of the ink between the ink channel unit 25 and the print heads 27. The indirect circulation of the ink between the ink channel unit 25 and the print heads 27 may be a portion of the ink circulation system.

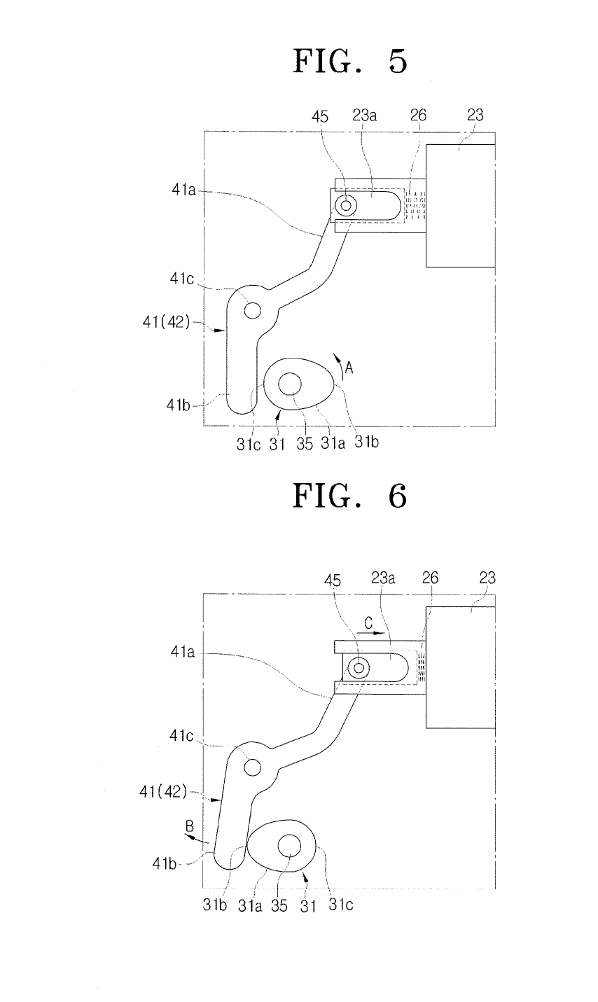

The four pumps 23 are disposed in pairs at both sides of the four ink tanks 21, that is, at opposite edges of the ink cartridge 20. It should be noted that FIG. 2 illustrates a pair of pumps 23 which share a common housing. Similarly, FIGS. 1 and 3 show two pairs of pumps 23, each pair sharing a common housing. Each pump 23 is provided with an operating rod 23a. The operating rod 23a projects from the pump 23 and is provided with a returning member 26 (see FIG. 5). The returning member 26 is represented here as a spring, but as used herein “returning member” refers to any element which elastically restores the operating rod 23a to a position projected from the pump 23. Therefore, when pressure is applied to the operating rod 23a, the operating rod 23a moves inside the pump 23 and when the pressure is removed from the operating rod 23a, the operating rod 23a is moved outside the pump 23 by the returning member 26 so as to be projected from the pump 23. Also, each pump 23 is in fluid communication with the ink channel unit 25 and the ink tank 21 via ink tubes 24.

The ink channel unit 25 supplies the print heads 27 with ink that is supplied from the plurality of ink tanks 21 via the plurality of pumps 23. Therefore, in this example, the ink tanks 21, the ink channel unit 25, the ink pumps 23, and the ink tubes 24 connected to corresponding ones of the pumps 23 to communicate with each of the ink tanks 21 and the ink channel unit 25 form the ink circulation system to circulate ink.

The plurality of print heads 27 is disposed at a bottom surface of the cartridge frame 29 of the ink cartridge 20. The print heads 27 are arranged in a direction corresponding to the width of a printing medium that passes through below the ink cartridge 20. Also, each print head 27 is provided with a plurality of nozzles 28 that form the ink supplied from the corresponding ink channel unit 25 into extremely small droplets of ink, and then fire the droplets of ink onto the printing medium. Therefore, the ink cartridge 20 is not required to reciprocate but instead can fire ink onto the whole width of a printing medium at once in a fixed position to form an image.

The cartridge frame 29 supports the four ink tanks 21, the four pumps 23, and the ink channel unit 25. The cartridge frame includes a structure to be detachably mounted to the main body frame 10. Therefore, the ink cartridge 20 can be separated from the main body frame 10. At the bottom surface of the cartridge frame 29 are formed two lever holes 29a through which lower portions 41b and 42b of first and second pumping levers 41 and 42 pass.

The pump driving unit 30 operates the plurality of pumps 23 for each of different color inks to circulate between the ink tank 21 and the ink channel unit 25. The pump driving unit 30 includes the first and second pumping levers 41 and 42, first and second pumping cams 31 and 32, and a driving unit (here comprising cam shaft 35, pump gear 37 and one-way clutch 38).

The first pumping lever 41 is rotatably disposed at the cartridge frame 29 of the ink cartridge 20 and formed so that an upper portion 41a thereof operates the operating rod 23a of the pump 23 and the lower portion 41b thereof contacts the first pumping cam 31. A hinge hole 41c is formed within the first pumping lever 41. The first pumping lever 41 can pivot by a predetermined angle with respect to the cartridge frame 29 by the hinge hole 41c and a hinge shaft (not illustrated) that is disposed near the lever hole 29a of the cartridge frame 29 of the ink cartridge 20. Therefore, when the ink cartridge 20 is separated from the main body frame 10, the first pumping lever 41 is separated from the main body frame 10 as one body with the ink cartridge 20. FIG. 4 illustrates the lower portions 41b and 42b of the first and second pumping levers 41 and 42 projected from the bottom surface of the separated ink cartridge 20.

The upper portion 41a of the first pumping lever 41 is connected to operate the operating rod 23a of the pump 23. The ink cartridge 20 according to this embodiment is provided with a connection member 45 so that the upper portion 41a of the first pumping lever 41 can press the operating rods 23a of the pair of pumps 23 together. The connection member 45 is formed in a shape of a shaft to pass through the operating rods 23a of the two pumps 23. When the upper portion 41a of the first pumping lever 41 presses the connection member 45, the two operating rods 23a move simultaneously inside each of the pumps 23 so that the pumps 23 operate. The first pumping lever 41 illustrated in FIG. 2 is described as one example only. In fact, as long as the pumping lever 41 or some similar mechanism is capable of pressing the operating rod 23a of the pump 23 (here, in response to a rotation of the pumping cam 31), the pumping lever 41 can be formed in various shapes or by other mechanisms.

The first pumping cam 31 is formed to periodically press the lower portion 41b of the first pumping lever 41 so that the upper portion 41a of the first pumping lever 41 presses the operating rod 23a. The first pumping cam 31 receives power from a driving motor 51 via the driving unit (here, cam shaft 35, pump gear 37 and one-way clutch 38) to rotate. At this time, the first pumping cam 31 has a cam profile so that the first pumping cam 31 smoothly contacts the lower portion 41b of the first pumping lever 41, maximally pushes the lower portion 41b thereof, and then, smoothly separates from the lower portion 41b thereof during one rotation. A pressure portion 31a of the first pumping cam 31 is formed as a part of the first pumping cam 31 to contact the first pumping lever 41 while the first pumping cam 31 rotates one time. Therefore, as the first pumping cam 31 rotates once, the upper portion 41a of the first pumping lever 41 presses the operating rod 23a once. In other words, when a highest point 31b of the first pumping cam 31 contacts the lower portion 41b of the first pumping lever 41, the upper portion 41a of the first pumping lever 41 presses maximally the operating rod 23a. In this example, when a lowest point 31c of the first pumping cam 31 faces the lower portion 41b of the first pumping lever 41, the upper portion 41a of the first pumping lever 41 does not press the operating rod 23a.

The second pumping lever 42 and the second pumping cam 32 are the substantially same as the first pumping lever 41 and pumping cam 31 described above; therefore, detailed descriptions thereof will not be repeated.

The driving unit includes a cam shaft 35 rotatably disposed at the main body frame 10 and a pump gear 37 that is disposed at an end of the cam shaft 35 and receives power from the driving motor 51. The first and second pumping cams 31 and 32 are disposed at the cam shaft 35 to correspond to the first and second pumping levers 41 and 42. In this example, the driving unit includes a one-way clutch 38 is disposed between the pump gear 37 and the cam shaft 35. The one-way clutch 38 allows power of the pump gear 37 to be transmitted to the cam shaft 35 when the pump gear 37 rotates in a one direction and not to be transmitted to the cam shaft 35 when the pump gear 37 rotates in an opposite direction. Therefore, when the driving motor 51 rotates in a first direction, the cam shaft 35 rotates as one body with the pump gear 37, and when the driving motor 51 rotates in a second direction, the pump gear 37 rotates but the cam shaft 35 does not rotate.

The driving motor 51 may be a motor used to drive other parts that an inkjet image forming apparatus uses to form images onto a printing medium. In other words, the driving motor 51 may be formed to rotate the cam shaft 35 and another part besides the cam shaft 35. For example, if a pickup roller, a feed roller, and a discharging roller are respectively rotated by different motors, one of a pickup motor to rotate the pickup roller, a feed motor to rotate the feed roller, and a discharging motor to rotate the discharging roller can be used as the driving motor 51. If an inkjet image forming apparatus has a main motor to rotate all of the pickup roller, the feed roller, and the discharging roller, the main motor can be used as the driving motor 51. Alternatively, the driving motor 51 may be dedicated to rotate only the cam shaft 35 or otherwise cause operation of the operating rods 23a of the pumps 23. In this alternative embodiment, a one-way clutch may not be used.

The inkjet image forming apparatus 1 according to this particular embodiment uses a dead nozzle compensation motor 51 of a dead nozzle compensation unit 50 as the driving motor. The dead nozzle compensation unit 50 is a device to move a printing medium in a predetermined pattern so that the inkjet image forming apparatus 1 can produce good quality images when some of the plurality of nozzles 28 of the plurality of print heads 27 are blocked. As noted above, the inkjet image forming apparatus 1 has an ink cartridge 20 with the plurality of print heads 27 arranged along a whole width of the printing medium, extending in a width direction of the printing medium to allow high speed printing.

Referring to FIG. 1, the dead nozzle compensation unit 50 includes the dead nozzle compensation motor 51, the pump gear 37, a first idle gear 52, a swing gear assembly 53, a second idle gear 57, a compensation gear 58, and a compensation roller 59.

The pump gear 37 is disposed at the cam shaft 35. The one-way clutch 38 is disposed between the pump gear 37 and the cam shaft 35. Therefore, when the driving motor 51 rotates in the first direction, the cam shaft 35 rotates as one body with the pump gear 37, and when the driving motor 51 rotates in the second direction, the pump gear 37 rotates but the cam shaft 35 does not rotate. In this embodiment, when the pump gear 37 rotates in the counterclockwise direction, the pump gear 37 and the cam shaft 35 rotate together, and when the pump gear 37 rotates in the clockwise direction, the cam shaft 35 does not rotate. The pump gear 37 may be formed in a two-stage gear. A bottom pump gear 37a is engaged with a pinion of the dead nozzle compensation motor 51 as the driving motor and a top pump gear 37b is engaged with the first idle gear 52.

The first idle gear 52 is disposed between the pump gear 37 and the swing gear assembly 53 and engaged with the pump gear 37. The swing gear assembly 53 includes a medium gear 54 to engage with the first idle gear 52, a swing gear 56 to engage with the medium gear 54, and a swing arm 55 to connect the swing gear 56 and the medium gear 54. Therefore, the swing gear 56 rotates along the medium gear 54 right or left according to a rotation direction of the medium gear 54.

The second idle gear 57 is disposed to engage with the swing gear 56 but not to engage with the medium gear 54. Therefore, when the swing gear 56 is engaged with the second idle gear 57 by the medium gear 54, the second idle gear 57 rotates.

The compensation gear 58 is coaxially disposed at a shaft of the compensation roller 59 to engage with the second idle gear 57. Therefore, when the second idle gear 57 rotates, the compensation gear 58 rotates so that the compensation roller 59 rotates. The rotation of the compensation roller 59 forces a printing medium to move.

When it receives a printing order from a connected host computer (not illustrated), the controller 60 controls the above-described parts to perform a printing operation. The controller 60 includes a memory (not illustrated) in which conditions and requirements that the controller 60 drives the driving motor 51 to operate the pump 23 are stored. The conditions and requirements may be stored in various forms, such as a program or in a look-up table, for example.

In this example, memory of the controller 60 stores three conditions that trigger the controller 60 to operate pumps 23.

First, when the inkjet image forming apparatus 1 is turned on, the controller 60 operates pumps 23. This has the purpose to supply ink of the ink tank 21 to the ink channel unit 25.

Second, when at least one ink tank 21 is replaced or when the ink cartridge 20 is separated from and then mounted to the main body frame 10, the controller 60 operates the pump 23. This has the purpose to remove bubbles that may occur in the ink circulation system due to outside air.

Third, the controller 60 may stop printing and operate the pump 23 at a predetermined interval during a printing operation. This has the purpose to remove bubbles that may occur in ink at the print head 27 due to the increased heat of the print head 27 from ink firing. Whether or not the controller 60 operates the pump 23 during the printing operation may be a function of the total amount of ink having been fired and/or the total number of printing media having been printed after the printing operation starts. If bubbles in the ink circulation system are removed, ink is stably supplied to the ink channel unit 25 so that the quality of printing may be enhanced.

The other structure and operation of the controller 60 are the substantially same as that of the conventional inkjet image forming apparatus; and therefore, detailed descriptions thereof are therefore omitted.

Hereinafter, an operation of the inkjet image forming apparatus 1 according to an embodiment will be described in detail with reference to the accompanying drawings.

When the inkjet image forming apparatus 1 is turned on, the controller 60 rotates the dead nozzle compensation motor 51 in the first direction for the pump gear 37 to rotate. In this embodiment, when the dead nozzle compensation motor 51 rotates in the first direction, the pump gear 37 rotates in the counterclockwise direction.

When the pump gear 37 rotates in the counterclockwise direction, the cam shaft 35 rotates as one body with the pump gear 37 via the one-way clutch 38. When the cam shaft 35 rotates, the first pumping cam 31 disposed at the cam shaft 35 rotates in the counterclockwise direction. Then, the pressure part 31a of the first pumping cam 31 contacts the lower portion 41b of the first pumping lever 41, and then, gradually pushes the lower portion 41b of the first pumping lever 41, to the left in FIG. 5. When the lower portion 41b of the first pumping lever 41 is pushed to the left, the upper portion 41a of the first pumping lever 41 moves to the right side as indicated by arrow C illustrated in FIG. 6. Then, the connection member 45 connected with the upper portion 41a of the first pumping lever 41 presses the operating rod 23a of the pump 23 so that the operating rod 23a is pushed inside the pump 23 compressing the returning member 26. When the highest point 31b of the first pumping cam 31 contacts the lower portion 41b of the first pumping lever 41, the lower portion 41b of the first pumping lever 41 is maximally pushed in the left and the upper portion 41a of the first pumping lever 41 maximally presses the operation rod 23a.

After the highest point 31b of the first pumping cam 31 leaves the first pumping lever 41 due to the continued rotation of the cam shaft 35, the operation rod 23a is pushed in a direction opposite to arrow C by the returning member 26 so that the upper portion 41a of the first pumping lever 41 is pushed in the direction opposite to arrow C. When the upper portion 41a of the first pumping lever 41 is pushed in the direction opposite to arrow C, the lower portion 41b of the first pumping lever 41 moves in a direction opposite to arrow B in FIG. 6, that is, to the right side. When the lowest point 31c of the first pumping cam 31 faces the lower portion 41b of the first pumping lever 41, the lower portion 41b of the first pumping lever 41 is spaced apart from the first pumping cam 31. At this time, the operation rod 23a returns to its original position as a result of the elasticity of the returning member 26.

A method of operating the second pumping lever 42 and the second pumping cam 32 to operate the pumps 23 is the substantially same as that of the first pumping lever 41 and the first pumping cam 31; and therefore, a detailed description thereof will be omitted.

As the rotation of the cam shaft 35 continues, the first and second pumping cams 31 and 32 and the first and second pumping levers 41 and 42 press the four operation rods 23a so that the four pumps 23 operate. When the amount of rotation of the cam shaft 35 reaches a reference value or after the cam shaft 35 rotates for a predetermined time, the controller 60 stops the dead nozzle compensation motor 51.

When the pump gear 37 rotates, the first idle gear 52 engaged with the pump gear 37 and the medium gear 54 engaged with the first idle gear 52 rotates together with the pump gear 37. When the pump gear 37 rotates in the counterclockwise direction, the first idle gear 52 rotates in the clockwise direction and the medium gear 54 rotates in the counterclockwise direction. If the medium gear 54 rotates in the counterclockwise direction, the swing arm 55 rotates in the counterclockwise direction. Therefore, the swing gear 56 also moves in the counterclockwise direction to be separated from the second idle gear 57 so that the power is not transmitted to the second idle gear 57.

When the controller 60 receives a printing order, the controller 60 controls the printing medium pickup unit and the printing medium transferring unit to position a printing medium below the ink cartridge 20. Then, the controller 60 controls the print heads 27 of the ink cartridge 20 to fire ink onto the printing medium, thereby forming images according to printing data.

At this time, the controller 60 operates the dead nozzle compensation unit 50 to prevent poor quality images from being generated due to the dead nozzles of the print heads 27. In other words, the controller 60 rotates the dead nozzle compensation motor 51 in the second direction. In this embodiment, when the dead nozzle compensation motor 51 rotates in the second direction, the pump gear 37 rotates in the clockwise direction.

When the pump gear 37 rotates, the first idle gear 52 engaged with the pump gear 37 and the medium gear 54 engaged with the first idle gear 52 rotate together with the pump gear 37. At this time, the pump gear 37 rotates in the clockwise direction so that the first idle gear 52 rotates in the counterclockwise direction and the medium gear 54 rotates in the clockwise direction. When the medium gear 54 rotates in the clockwise direction, the swing arm 55 rotates in the clockwise direction. Therefore, the swing gear 56 also moves in the clockwise direction to engage with the second idle gear 57. As a result, a rotational force of the pump gear 37 is transmitted to the second idle gear 57 and the compensation gear 58 via the swing gear 56. Then, the controller 60 can control the dead nozzle compensation motor 51 to operate the compensation gear 58 according to a predetermined pattern. As a result, the controller 60 controls the compensation roller 59 to move a printing medium, thereby compensating the dead nozzles of the print heads 27. Details of how the controller 60 controls the dead nozzle compensation unit 50 to perform a printing operation is not a feature of the present general inventive concept; and therefore, a detailed description thereof will be omitted.

On the other hand, because the pump gear 37 is connected with the cam shaft 35 via the one-way clutch 38, when the pump gear 37 rotates in the clockwise direction, the rotation of the pump gear 37 is not transmitted to the cam shaft 35. As a result, when the controller 60 controls the dead nozzle compensation motor 51 to compensate the dead nozzle, the pump 23 does not operate.

During a printing operation the controller 60 determines if one of the pump operation conditions stored in the memory is satisfied. If one of the pump operation conditions is satisfied, the controller 60 performs a pump operation, and then rotates the dead nozzle compensation motor 51 in the first direction. Then, the first and second pumping levers 41 and 42 and the first and second pumping cams 31 and 32 operate the four pumps 23 of the ink cartridge 20 to circulate ink. As a result, bubbles which may exist in the ink circulation system are removed. The method of operating the first and second pumping levers 41 and 42 and the first and second pumping cams 31 and 32 by the dead nozzle compensation motor 51 may be the same as that in the above description; and therefore, a detailed description thereof will be omitted.

Also, when at least one of the plurality of ink tanks 21 is replaced during a printing operation, and/or when the image forming apparatus is turned on, the controller 60 rotates the dead nozzle compensation motor 51 in the first direction to operate the four pumps 23 as described above. Then, ink is circulated in the ink circulation system so that bubbles of ink are removed.

It is again emphasized that the above description simply sets for examples of the general inventive concept. For example, the above description describes a color inkjet image forming apparatus 1 that uses four-color inks to form color images is used as an example of the inkjet image forming apparatus according to an embodiment of the present general inventive concept; however, this should not be considered as limiting. The application may be applied to an inkjet image forming apparatus that uses one-color ink to form images. In this case, one pump may be used so that only one pumping lever and one pumping cam also are needed. The other structure of the image forming apparatus may be substantially same as that of the color inkjet image forming apparatus as described above.

As another example, the general inventive concept may be applied to inkjet image forming apparatuses that use six or more color inks to form a color image. In this case, six or more ink tanks corresponding to the number of used colors may be disposed at the ink cartridge and six or more pumps may be also disposed corresponding to the number of the ink tanks. The number of the pumping levers and pumping cams may be increased corresponding to the number of the pairs of the pumps to operate the six or more pumps. In this case, the other structures of the inkjet image forming apparatus may be substantially the same as that of the color inkjet image forming apparatus as described above.

Furthermore, in the above description, the dead nozzle compensation motor 51 is used as an example of the driving motor to drive the pump 23 of the ink cartridge 20; again however, this is only one example and should not be considered as limiting. A dedicated motor, or any of the feed motor, the pickup motor, the discharge motor, and so on may be used as the driving motor to operate the pump of the ink cartridge.

In the inkjet image forming apparatus according to an embodiment of the present general inventive concept, the driving motor operates the pump as describe above so that ink is circulated between the ink tank and the print heads.

Also, the inkjet image forming apparatus according to an embodiment of the present general inventive concept circulates ink to remove bubbles to occur in the ink circulation system so that ink may be stably supplied to the print heads.

Furthermore, in the inkjet image forming apparatus according to an embodiment of the present general inventive concept, the driving unit for operating the pump to circulate ink is disposed at not with the ink cartridge but with the main body frame so that a manufacturing cost of the ink cartridge is decreased.

Also, the inkjet image forming apparatus according to an embodiment of the present general inventive concept uses not an exclusive motor as the motor to operate the ink circulation pump but a motor having another usage such as the dead nozzle compensation motor so that the structure of the inkjet image forming apparatus may be simplified and the manufacturing cost thereof is decreased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. Terms in the claims should be given their broadest interpretation consistent with the general inventive concept as set forth in this description. For example, the terms “coupled” and “connect” (and derivations thereof) are used to connote both direct and indirect connections/couplings. Claims are not intended to be interpreted under 112 sixth paragraph unless the phrase “means for” and an associated function appear in a claim and the claim fails to recite sufficient structure to perform such function.

What is claimed is:

1. An inkjet image forming apparatus comprising:
at least one pump disposed at an ink cartridge that is detachably disposed at a main body frame;
at least one pump driving unit to drive the at least one pump;
a driving motor to drive the at least one pump driving unit if rotating in a first direction and to drive another part of an image forming apparatus if rotating in a second direction; and
a controller to control the driving motor.

2. The inkjet image forming apparatus of claim 1, wherein the driving motor comprises one of a dead nozzle compensation motor, a pickup motor, a feed motor, and a discharging motor.

3. The inkjet image forming apparatus of claim 1, wherein the at least one pump driving unit comprises;
a pumping lever rotatably disposed at the ink cartridge and having an upper portion thereof connected with an operating rod of the at least one pump;
a pumping cam disposed near a lower portion of the pumping lever and formed to move the operating rod when the pumping cam contacts the lower portion of the pumping lever; and
a gear driving unit to receive power from the driving motor to rotate the pumping cam.

4. The inkjet image forming apparatus of claim 1, wherein the controller rotates the driving motor in the first direction upon detecting an event, the event being selected from the group consisting of: the image forming apparatus is turned on, the ink cartridge is separated from and then again disposed at the main body frame, and an ink tank of the ink cartridge is replaced.

5. The inkjet image forming apparatus of claim 1, wherein if the amount of fired ink reaches a reference value during a printing operation, the controller rotates the driving motor in the first direction.

6. An inkjet image forming apparatus comprising:
a plurality of pumps disposed at an ink cartridge that is detachably disposed at a main body frame;
a pump driving unit to drive the plurality of pumps;
a dead nozzle compensation motor to drive the pump driving unit if rotating in a first direction and to drive a compensation roller if rotating in a second direction; and
a controller to control the dead nozzle compensation motor.

7. The inkjet image forming apparatus of claim 6, wherein the plurality of pumps is disposed in pairs at the ink cartridge.

8. The inkjet image forming apparatus of claim 6, wherein the gear driving unit comprises;
a cam shaft rotatably disposed at the main body frame; and
a pump gear disposed at an end of the cam shaft to receive power from the dead nozzle compensation motor.

9. The inkjet image forming apparatus of claim 6, wherein the controller rotates the dead nozzle compensation motor in the first direction upon detecting an event, the event selected from the group consisting of: the inkjet image forming apparatus is turned on, the ink cartridge is separated from and then again disposed at the main body frame, and an ink tank of the ink cartridge is replaced.

10. The inkjet image forming apparatus of claim 6, wherein if the amount of fired ink reaches a reference value during a printing operation, the controller rotates the dead nozzle compensation motor in the first direction.

11. An inkjet printer comprising:
a main body frame;
an ink cartridge removably attached to the frame, the ink cartridge including at least one ink tank, a plurality of print heads arranged in a direction transverse to a travel direction of a printing medium to eject ink onto the printing medium, and at least one pump in fluid communication with the ink tank; and
a motor fixed to the main body frame having a drive shaft in mechanical communication with the at least one pump to transmit a mechanical force to operate the at least one pump.

12. The inkjet printer of claim 11, wherein the motor is shared to drive other mechanical elements of the printer during a period of time that the pump is not operating.

13. The inkjet printer of claim 12, further comprising:
a clutch connected to the motor to transmit the mechanical force to operate said at least one pump only when the drive shaft of the motor rotates in a first direction.

14. The inkjet printer of claim 11, further comprising:
a controller to operate the at least one pump in as part of an initialization routine after the inkjet printer is turned on.

15. The inkjet printer of claim 11, further comprising:
a controller to operate the at least one pump is turned on in response to attaching the ink cartridge to the main body frame.

16. An ink cartridge usable with an inkjet printer, comprising:
a cartridge frame;
at least one ink tank disposed within the cartridge frame;
at least one pump disposed within the cartridge frame in fluid communication with the ink tank, including at least one operating rod for operating a corresponding at least one pump;
at least one lever rotatably connected to said cartridge frame by a hinge, the at least one lever operable to exert a force on a corresponding at least one operating rod when a portion of the said lever receives a mechanical force exterior from the cartridge frame; and
a plurality of print heads exposed through holes in the cartridge frame and arranged in a direction transverse to a travel direction of a printing medium to eject ink onto the printing medium.

17. The ink cartridge of claim 24, wherein the at least one lever is mounted to an interior portion of the cartridge frame and includes a terminal portion extending through a corresponding at least one hole in the cartridge frame to receive the mechanical force exterior from the cartridge frame.

18. The ink cartridge of claim 16, further comprising:
a channel member providing a fluid communication channel between the at least one ink tank and the print heads,
wherein operating of the at least one pump circulates ink within the channel member to remove bubbles.

19. An ink cartridge usable with an image forming apparatus, comprising:
a body frame;
at least one ink tank mounted in the body frame to supply ink;
a plurality of print heads mounted in the body frame and arranged in a direction traverse to a travel direction of a printing medium to eject the supplied ink onto the printing medium; and
at least one pump mounted in the body frame in fluid communication with the ink tank and at least one corresponding one of the plurality of print heads.
